(19) United States
(12) Patent Application Publication
(10) Pub. No.: US 2014/0350998 A1
(43) Pub. Date: Nov. 27, 2014

(54) PROJECT RISK PATTERNS MODELING AND RISK MITIGATION

(71) Applicant: TATA CONSULTANCE SERVICES LIMITED, Mumbai (IN)

(72) Inventors: Tirumala Rao VINNAKOTA, Hyderabad (IN); Narayana Guru Prasada Lakshmi MANDALEEKA, Hyderabad (IN)

(73) Assignee: TATA CONSULTANCE SERVICES LIMITED, Mumbai (IN)

(21) Appl. No.: 13/899,689

(22) Filed: May 22, 2013

(51) Int. Cl. G06Q 10/06

(52) U.S. Cl. CPC G06Q 10/0635
USPC 705/7.28

(57) ABSTRACT

Project risk patterns modeling and risk mitigation. The method includes obtaining potential risk factors associated with a project. Further, at least one interacting potential risk factor influencing at least another potential risk factor may be ascertained. The ascertaining is performed based on interaction indicators. The interaction indicators are indicative of an interaction between the at least one interacting potential risk factor and the at least another potential risk factor. Further, a risk emergence pattern is identified based on the interaction between the at least one interacting potential risk factor and the at least another potential risk factor. The risk emergence pattern is indicative of a recurrent interaction between the at least one interacting potential risk factor and the at least another potential risk factor.

### TECHNICAL FIELD

The present subject matter, in general, relates to project management and, in particular, relates to project risk patterns modeling and risk mitigation.

### BACKGROUND

Generally, growth and development of an organization relies on successful execution of various projects running in the organization. Each project may include a plurality of phases or stages to achieve a favorable outcome. For example, a project may include a designing stage, simulation stage, planning stage, and implementation stage. However, at different stages, there may be numerous factors influencing the advancement of the project. As would be understood, as the magnitude or complexity of the project increases, number of factors influencing the project also increases. Also, any change in one or more numerous factors and interactions among the risk factors may hinder the progress of the project, thereby instigating a possibility of failure of the project.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a network environment implementing a project risk patterns modeling and risk mitigation system, in accordance with an embodiment of the present subject matter.

FIG. 2 illustrates an example of risk interaction mapping, in accordance with an embodiment of the present subject matter.

FIG. 3(a), FIG. 3(b), and FIG. 3(c) illustrate examples of risk patterns generated by the project risk patterns modeling and risk mitigation system, in accordance with an embodiment of the present subject matter.

FIG. 4 illustrates a method for project risk patterns modeling and risk mitigation, in accordance with an embodiment of the present subject matter.

### DETAILED DESCRIPTION

System(s) and method(s) for project risk patterns modeling and risk mitigation are described herein. Generally, organizations work simultaneously on different projects. The projects may include but are not limited to research projects, procurement projects, manufacturing projects, construction projects, and software projects. Since growth and development of an organization relies on success of their projects, it is relevant for the organizations to ensure successful completion of the projects to establish or sustain their position in the industry. Consequently, the organizations prefer to invest their resources in an optimal manner for effectively handling the various projects.

As would be understood, there may be a plurality of factors, also referred to as risk factors, associated with a project influencing the advancement of the project. In one example, the risk factors may include lack of infrastructural resources and manpower, inadequate skill-set of the members of the organization, and insufficient funds available. It may be relevant for the organizations to regulate the risk factors in an effective manner to ensure a productive outcome of the projects.

Generally, each risk factor is addressed as being independent of the other risk factors. In other words, effect of each risk factor on the progress of the project may be considered and regulated independently. Therefore, a fragmented approach of risk management is adapted.

However, the risk factors may interact with each other during the execution of the project. In other words, the risk factors may be co-dependent. For example, a risk factor may not pose a threat to a project when considered independently. However, in combination with other risk factors, it may influence the successful completion of the project. Therefore, an effect of each risk factor considered independently, may be different than the cumulative effect of interaction between various risk factors. Therefore, the conventional risk regulation techniques may not facilitate an effective planning and execution of a project.

Further, various operations to be performed in a project may be categorized in a plurality of stages. In one example, the plurality of stages may include a proposal stage, a design stage, a simulation stage, and an implementation stage. Accordingly, the risk factors may also possess dynamic attributes. For example, a risk factor may be relevant, in teems of severity, in one phase of the project, whereas it may not hinder the progress of the project in another phase. In other words, behavior or influence of a risk factor on the progress of the project may vary during the various stages of the project. However, in the conventional techniques, the dynamicity of the attributes influencing the project execution may not be considered for risk management.

The system and method according to the present subject matter provides an effective and comprehensive approach for project risk pattern modeling and risk mitigation. A project risk pattern modeling and risk mitigation system, hereinafter referred to as system, allows a successful completion of various projects running in an organization. The system may obtain a plurality of potential risk factors. Further, an interaction indicator may be assigned to each of the plurality of potential risk factors. The interaction indicator corresponding to a potential risk factor indicates the interaction of the potential risk factor with other potential risk factors. On the basis of the interaction indicators, a risk interaction mapping corresponding to the plurality of the potential risk factors may be determined. Further, a plurality of risk patterns including a risk emergence pattern may be identified based on the risk interaction mapping and risk patterns modeling. The risk emergence pattern is indicative of a recurrent interaction among a plurality of potential risk factors.

As mentioned above, the system may obtain a plurality of factors, referred to as potential risk factors associated with a project and influencing progress of the project. Therefore, in an example, the potential risk factors may be understood as factors capable of posing a threat or risk to the advancement of the project. Further, each of the plurality of potential risk factors may be associated with an interaction indicator. The interaction indicator associated with a potential risk factor may indicate an interaction of the potential risk factor with other potential risk factors to consider the dynamic nature of the potential risk factors. For example, interaction may be understood as influence of a potential risk factor A on a potential risk factor B, or influence of the potential risk factor B on the potential risk factor A, or interdependence between the potential risk factors A and B.

Further, the dynamic attributes of the potential risk factors may correspond to the dynamic behavior of the potential risk factors in different stages of the project. For example, in a construction project, lack of man-power may not be critical in designing stage of the construction project. However, during construction stage, lack of man-power may hamper the progress of the project substantially and may lead to project failure. The dynamic attributes may also be understood as attributes corresponding to dynamicity of the relationship among the plurality of potential risk factors. For example, relationship between a potential risk factor A and a potential risk factor B may vary in different stages of a project. Considering the dynamic nature of the potential risk factors and the dynamic nature of relationship among the plurality of potential risk factors for the risk management ensures that an organization stays updated about any change in any of the potential risk factors. Therefore, mitigation of the potential risk factors may be performed accordingly.

In one implementation, the interaction indicators may include, but are not limited to an influencing parameter and a dependency parameter. The influencing parameter of an interaction indicator corresponding to a potential risk factor indicates a plurality of the potential risk factors interacting with the potential risk factor. On the other hand, the dependency parameter indicates the nature of dependency of the corresponding potential risk factor with the other potential risk factors.

Further, based on the interaction indicators, the system may determine one or more interacting potential risk factors. An interacting potential risk factor may be understood as a potential risk factor interacting with at least another potential risk factor. Further, the system ascertains a risk interaction mapping corresponding to the plurality of interacting potential risk factors. The risk interaction mapping may be indicative of various interactions between the potential risk factors.

In an implementation, one or more risk patterns may be modeled based on the risk interaction mapping. The risk patterns are indicative of behavior of the plurality of risk factors during project execution. Therefore, modeling of the risk patterns can be used to identify the risks emerging out of the risk patterns that may be relevant for the unhindered progress of the project. In an example, the risk patterns may include but are not limited to risk emergence patterns, risk divergence patterns and risk convergence patterns. Further, the risk emergence patterns, the risk divergence patterns and risk convergence patterns may be identified based on the automatic generation of the risk patterns. As would be understood, one or more of each type of risk patterns may be identified.

The risk emergence pattern may identify multiple interacting potential risk factors forming a positive feedback loop based on a recurrent interaction among the interacting potential risk factors. For example, a potential risk factor A may influence a potential risk factor B. Also, the potential risk factor B influences a potential risk factor C. Further, the potential risk factor C influences the potential risk factor A. As mentioned earlier, the potential risk factor A again influences the potential risk factor B, and so on. Therefore, a perennial loop may be formed between some of the plurality of interacting potential risk factors leading to project failure. As the potential risk factors forming the perennial loop may keep influencing each other without being mitigated, the intensity or magnitude of the potential risk factors keeps increasing. Therefore, the intensification of the potential risk factors forming the perennial loop may give rise to emergent risks, which may further lead to project failure.

Further, the risk divergence pattern may identify at least one interacting potential risk factor which may further influence multiple potential risk factors and therefore leading to project failure. Therefore, one potential risk factor influences other potential risk factors to instigate the project failure. In other words, the one potential factor may be considered as the root cause or fundamental cause of the project failure. Furthermore, the risk convergence pattern identifies an interacting potential risk factor influenced by multiple potential risk factors. Therefore, multiple interacting potential risk factors are convergent to influence the interacting potential risk factor instigating the project failure. In other words, there are multiple potential risk factors leading a project to failure.

In one implementation, based on the plurality of risk patterns, a risk mitigation report corresponding to the plurality of potential risk factors may be generated. Subsequently, the project may be planned and executed based on the risk mitigation report.

As would be gathered, in addition to addressing the independent effect of the potential risk factors, the interaction indicators designated with each of the plurality of potential risk factors allow the system to consider and analyze risks associated with the project based on the interaction between the plurality of potential risk factors. Therefore, the system adopts a comprehensive approach for risk patterns modeling and risk mitigation. Further, the interaction indicators may also consider the dynamic attributes of the potential risk factors. Therefore, the potential risk factors may be mitigated accordingly.

These and other advantages of the present subject matter would be described in greater detail in conjunction with the following figures. While aspects of described system(s) and method(s) for project risk patterns modeling and risk mitigation can be implemented in any number of different computing systems, environments, and/or configurations, the embodiments are described in the context of the following exemplary system(s).

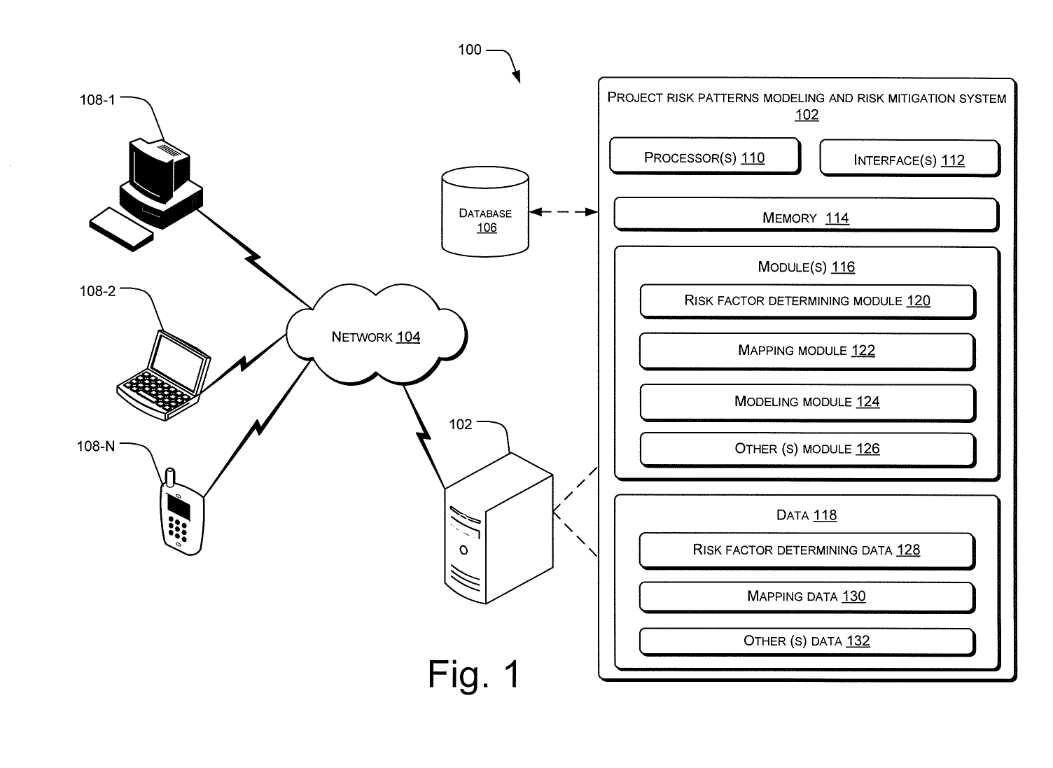

FIG. 1 illustrates a network environment 100 implementing project risk patterns modeling and risk mitigation system 102 (hereinafter referred to as, system 102), according to an embodiment of the present subject matter. In the network environment 100, the system 102 is connected to a network 104. Further, the system 102 is connected to a database 106. Additionally, the network environment 100 includes one or more client devices 108-1, 108-2 . . . 108-N, collectively referred to as client devices 108 and individually referred to as client device 108, connected to the network 104. In one implementation, the client device 108 may be used to run registered processes that are monitored by the system 102. In another implementation, the client device 108 may be used to view the logs pertaining to the execution of the registered processes. In yet another implementation, the client device 108 may be used for both purposes.

The system 102 can be implemented as any set of computing devices connected to the network 104. For instance, the system 102 may be implemented as workstations, personal computers, desktop computers, multiprocessor systems, laptops, network computers, minicomputers, servers, and the like. In addition, the system 102 may include multiple servers to perform mirrored tasks for users.

Furthermore, the system 102 can be connected to the client devices 108 through the network 104. Examples of the client devices 108 include, but are not limited to, personal computers, desktop computers, smart phones, PDAs, and laptops. Communication links between the client devices 108 and the system 102 are enabled through various forms of connections, for example, via dial-up modem connections, cable links, digital subscriber lines (DSL), wireless or satellite links, or any other suitable form of communication.

Moreover, the network 104 may be a wireless network, a wired network, or a combination thereof. The network 104 can also be an individual network or a collection of many such individual networks interconnected with each other and functioning as a single large network, e.g., the interne or an intranet. The network 104 can be implemented as one of the different types of networks, such as intranet, local area network (LAN), wide area network (WAN), the internet, and such. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 104 may include network devices, such as network switches, hubs, routers, host bus adapters (HBAs), for providing a link between the system 102 and the client devices 108. The network devices within the network 104 may interact with the system 102 and the client devices 108 through communication links.

In said embodiment, the system 102 includes one or more processor(s) 110, interface(s) 112, and a memory 114 coupled to the processor 110. The processor 110 can be a single processing unit or a number of units, all of which could also include multiple computing units. The processor 110 may be implemented as one or more microprocessors, microcomputers, microcontrollers, digital signal processors, central processing units, state machines, logic circuitries, and/or any devices that manipulate signals based on operational instructions. Among other capabilities, the processor 110 fetches and executes computer-readable instructions and data stored in the memory 114.

The interfaces 112 may include a variety of software and hardware interfaces, for example, interface for peripheral device(s), such as a keyboard, a mouse, an external memory, and a printer. Further, the interfaces 112 may enable the system 102 to communicate with other computing devices, such as web servers and external data repositories, such as the database 106, in the network environment 100. The interfaces 112 may facilitate multiple communications within a wide variety of protocols and networks, such as a network, including wired networks, e.g., LAN, cable, etc., and wireless networks, e.g., WLAN, cellular, satellite, etc. The interfaces 112 may include one or more ports for connecting the system 102 to a number of computing devices.

The memory 114 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The non-transitory computer-readable medium, however, excludes a transitory, propagating signal. The memory 114 also includes module(s) 116 and data 118.

The module(s) 116 include routines, programs, objects, components, data structures, etc., which perform particular tasks or implement particular abstract data types. In one implementation, the module(s) 116 includes a risk factor determining module 120, a mapping module 122, a modeling module 124 and other module(s) 126. The other module(s) 126 may include programs or coded instructions that supplement applications and functions of the system 102.

On the other hand, the data 118, inter alia serves as a repository for storing data processed, received, and generated by one or more of the module(s) 116. The data 118 includes, for example, a risk factor determining data 128, a mapping data 130, and other data 132. The other data 132 includes data generated as a result of the execution of one or more modules in the module(s) 116.

In one implementation, the system 102 may model risk patterns and provide methods to mitigate risks associated with a project. In one implementation, the risk factor determining module 120 obtains a plurality of potential risk factors associated with a project. In one example, the plurality of potential risk factors may include, but are not limited to unrealistic project deadlines, lack of coordination between on-site and off-site teams, lack of appropriate skill-set, unavailability of an onsite project manager, change in customer requirements, delay in decision making, and improper distribution of workload. In the present implementation, there may be an interaction indicator associated with each of the plurality of potential risk factors.

An interaction indicator corresponding to a potential risk factor may be indicative of interactions of the potential risk factors with at least another potential risk factor. In one implementation, the interaction indicators may include an influence parameter and a dependency parameter. The influence parameter corresponding to a potential risk factor may indicate the other potential risk factors which may be influenced by the potential risk factor. In one example, a potential risk factor A interacts with a potential risk factor B, a potential factor F, and a potential risk factor X. Therefore, an influence parameter of an interaction indicator corresponding to the potential risk factor A may indicate the potential risk factors B, F and X. On the other hand, dependency parameter may indicate nature of dependency between two potential risk factors.

As mentioned in previous example, based on the influence parameter, it may be determined that the potential risk factor A interacts with the potential risk factor B. Continuing with the present example, the dependency parameter may determine whether the potential risk factor A influences the potential risk factor B or vice-versa or both the potential risk factors A and B influence each other. Also, the interaction indicators may consider dynamic attributes of the potential risk factors to determine the effect of the potential risk factors at various stages of the project. In one implementation, dynamic nature of a potential risk factor may be considered by taking into account the behavior of the potential risk factor at different stages during execution of previous projects of similar nature. Consequently, the interaction indicator may be assigned to the potential risk factor based on the behavior of potential risk factor in the current context. Therefore, interaction indicators corresponding to each of a plurality of potential risk factors may be assigned before the initiation of execution of a project. In another implementation, on the basis of the behavior of a potential risk factor in each stage of the project, interaction indicators corresponding to each of the potential risk factors may be assigned or updated in each stage of the project. In yet another implementation, interaction indicators corresponding to each of the plurality of potential risk factors may be assigned and updated based on a user preference considering the current context.

In one implementation, the risk factor determining module 120 may obtain the plurality of potential risk factors from internal database of an organization, external data repositories, and online portals. In one implementation, the plurality of potential risk factors may be obtained based on the nature of project. For example, in case of a procurement project, the risk factor determining module 120 may obtain potential risk factors pertinent to procurement projects based on earlier execution of such projects in an organization or elsewhere in the world. In another implementation, the risk factor determining module 120 may obtain a plurality of potential risk factors on the basis of user preference.

Further, based on the interaction indicators designated with the plurality of potential risk factors, the risk factor determining module 120 determines the potential risk factors influencing at least another potential risk factor, hereinafter referred to as interacting potential risk factors. In one implementation, some of the plurality of potential risk factors may act independently, i.e., may not influence other potential risk factors throughout the execution of the project. In one implementation, the risk factor determining module 120 stores the data in the risk factor determining data 128.

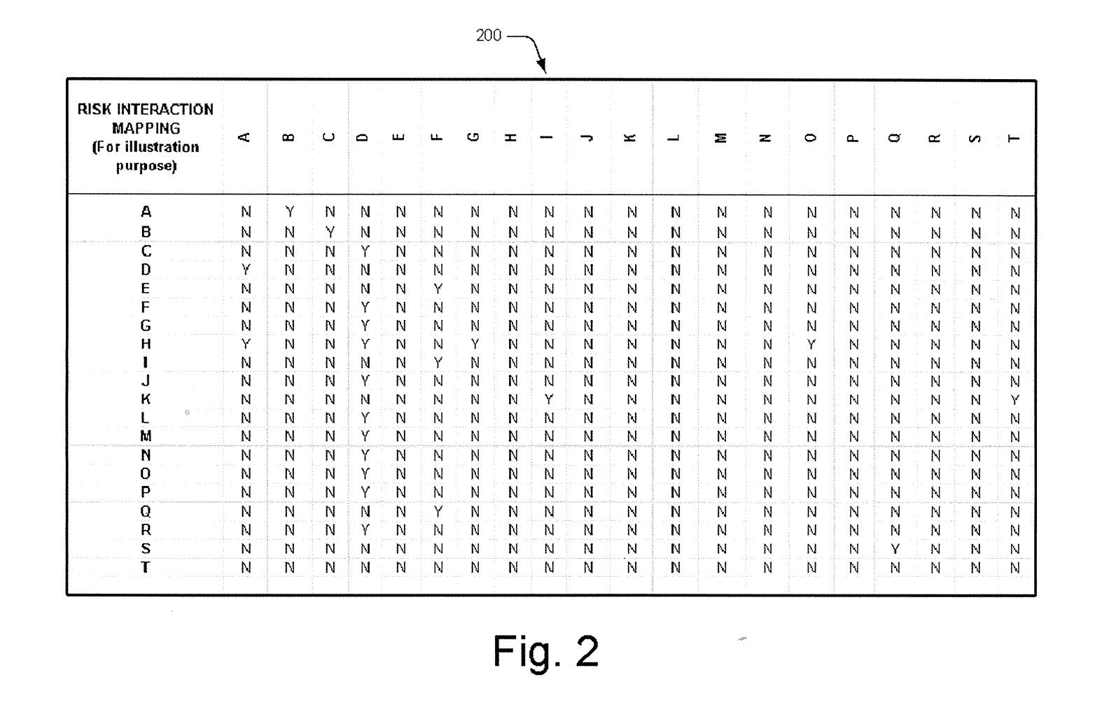

In one implementation, the mapping module 122 determines a risk interaction mapping based on the obtained potential risk factors. The risk interaction mapping may depict various interactions among the plurality of potential risk factors. The risk interaction mapping may be explained in detail with reference to FIG. 2. Further, in one implementation, the mapping module 122 stores the data in the mapping data 130.

Continuing with the present implementation, the modeling module 124 further models a plurality of risk patterns based on the risk interaction mapping. The plurality of risk patterns may include, but are not limited to risk emergence patterns, risk convergence patterns, and risk divergence patterns. In other words, the modeling module 124 provides a graphical representation of the risk patterns.

In one implementation, the modeling module 124 identifies the risk emergence patterns, the risk convergence patterns and the risk divergence patterns from the plurality of risk patterns. In one implementation, a user may select one of the options provided in a risk pattern menu. The options may include but are not limited to a risk emergence pattern, a risk convergence pattern and a risk divergence pattern. Therefore, the user may select one of the risk emergence pattern, the risk convergence pattern and the risk divergence pattern. Subsequently, the modeling module 124 may identify the selected risk pattern from the plurality of risk patterns. Further, on the basis of the identification, the selected risk pattern may be displayed to the user. As would be appreciated by a person skilled in the art, the modeling module 124 may identify one or more of each type of the risk patterns.

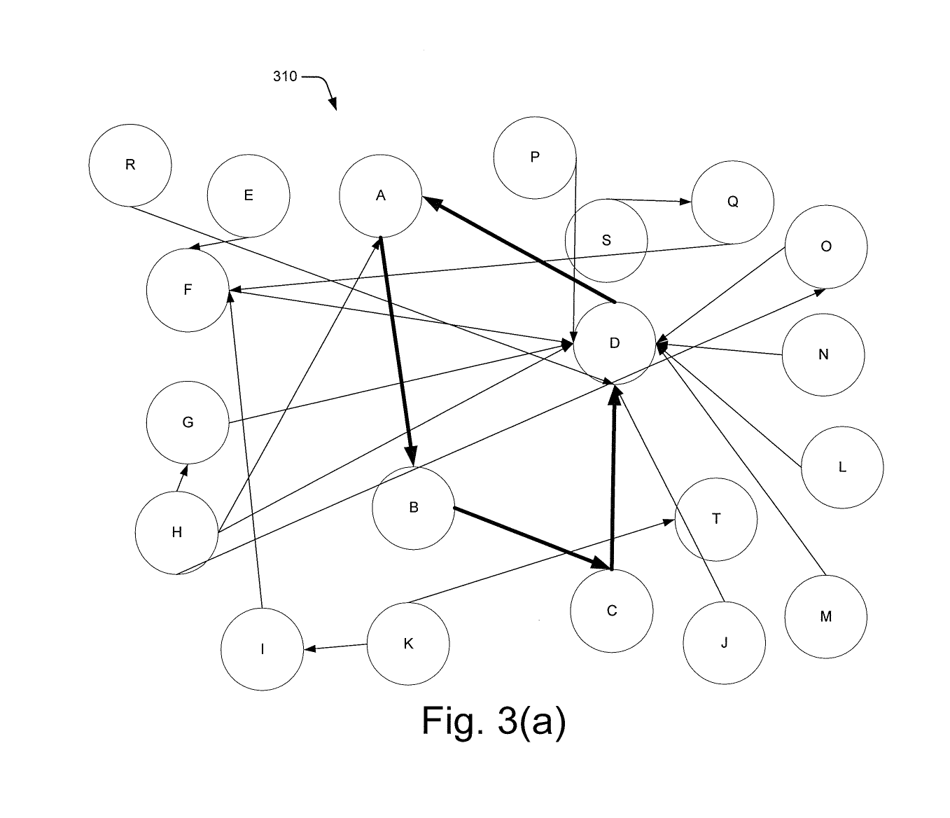

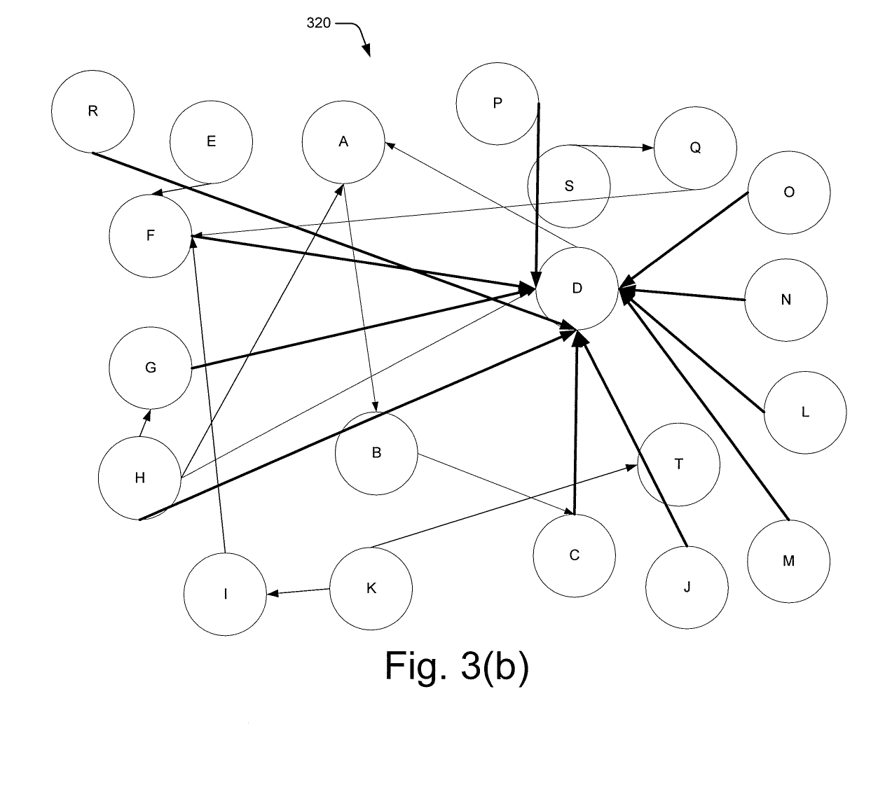

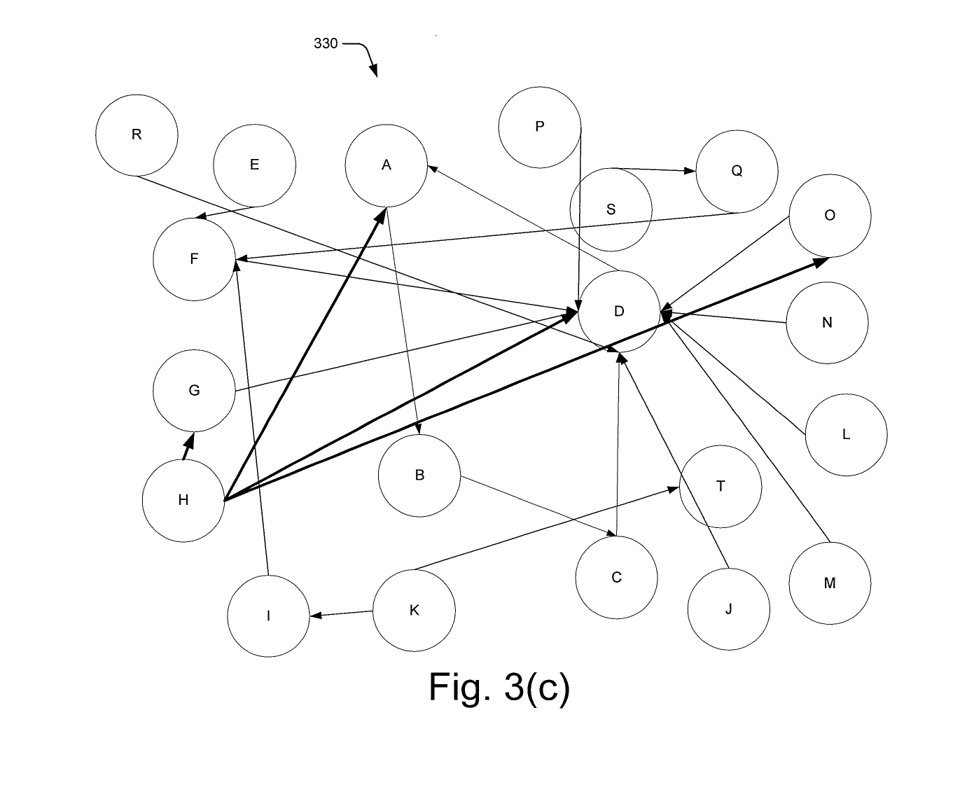

In a risk emergence pattern, at least one positive feedback loop formed by two or more interacting potential risk factors may be determined. The at least one positive feedback loop may be formed based on the interaction indicators of the corresponding interacting potential risk factors. The interacting potential risk factors forming a positive feedback may intensify continuously based on the recurrent interactions between them, and thereby eventually leading to an emergent risk instigating the project failure. Further, the risk emergence pattern may be explained in detail with reference to FIG. 3(a).

Further, the modeling module 124 may determine the risk convergence patterns. A risk convergence pattern may determine at least one interacting potential risk factor getting influenced by two or more potential risk factors, thereby leading to instigation of project failure. For example, a potential risk factor C, a potential risk factor D, a potential risk factor K, and a potential risk factor P may influence a potential risk factor J. Therefore, the potential risk factor J may keep on intensifying and may lead to the project failure. Further, the risk convergence pattern may be explained in detail in FIG. 3(b).

In one implementation, the modeling module 124 may determine the risk divergence patterns. A risk divergence pattern may determine at least one potential risk factor influencing more than two potential risk factors. For example, a potential risk factor M may be influencing a potential risk factor N, a potential risk factor L, a potential risk factor U, and a potential risk factor V. Therefore, the potential risk factor M may be considered as a critical potential risk factor as the potential risk factor M is influencing other potential factors, thereby instigating the project failure. Further, the risk divergence pattern may be explained in detail with reference to FIG. 3(c).

In another implementation, the modeling module 124 may generate a risk mitigation report on the basis of the modeling of the risk patterns. The risk mitigation report may include the plurality of potential risk factors prioritized according to their criticality and determined on the basis of the plurality of risk patterns. Therefore, an organization may address the potential risk factors with greater criticality prior to the potential risk factors with lesser criticality. Subsequently, mitigation of the risks analyzed on the basis of the plurality of risk patterns may be performed accordingly. In a further implementation, the modeling module 124 may generate the risk mitigation report with mitigation measures corresponding to the plurality of the potential risk factors. Further, in one implementation, the modeling module 124 may store the data in the other(s) data 132.

Further, an organization may execute the project based on the potential risk factors determined on the basis of the plurality of potential risk factors. Therefore, the system 102 ensures a successful execution of various projects by identifying the plurality of risk patterns, and subsequently, mitigating the potential risk factors.

FIG. 2 illustrates an example of risk interaction mapping 200, in accordance with an embodiment of the present subject matter. As mentioned earlier, the risk interaction mapping may be generated based on interaction indicators associated with each of a plurality of potential risk factors.

In the present implementation, the risk interaction mapping is generated in a spread-sheet to depict the interaction between a plurality of potential risk factors A, B, C, D, E, . . . , T among each other. In one implementation, if a potential risk factor influences another potential risk factor, then “Y” may be put in the corresponding cell. Similarly, if a potential risk factor may not influence another potential risk factor, then “N” may be put in the corresponding cell. For example, the potential risk factor A influences potential risk factors B and therefore, “Y” is put in the respective cell in the risk interaction mapping as shown in the FIG. 2. Therefore, a risk interaction mapping corresponding to the plurality of potential risk factors may be generated accordingly. Based on the risk interaction mapping, the modeling module 124 can generate various risk patterns.

FIG. 3(a), FIG. 3(b) and FIG. 3(c) illustrate a representation of a risk emergence pattern, a risk convergence pattern, and a risk divergence pattern identified on the basis of risk interaction mapping by the system 102, according to one embodiment of the present subject matter. Further, the representation is provided for a better clarity of the subject matter and should not be considered as limiting, and the risk interaction mapping may be represented using various other forms of representation as would be appreciated by a person skilled in the art. Also, the representation portrays one risk emergence pattern, one convergence pattern and one divergence pattern. However, a plurality of such patterns may be modeled based on the risk interaction mapping. As mentioned in the description of FIG. 1, the mapping module 122 may generate a risk interaction mapping based on interaction indicators designated with a plurality of potential risk factors associated with a project.

With reference to the FIG. 3(a), FIG. 3(b) and FIG. 3(c), various risk patterns are depicted where a plurality of interacting potential risk factors, referred to as A, B, C, . . . , T interact with each other.

FIG. 3(a) depicts a risk pattern 310, modeled on the basis of the risk interaction mapping, for identifying emergence risk patterns. Further, as can be seen from the risk pattern 310, the potential risk factor A leads to the potential risk factor B, which further leads to the potential risk factor C. Subsequently, the potential risk factor C leads to the potential risk factor D. Further, the potential risk factor D leads back to the potential risk factors A. As mentioned earlier, the potential risk factor A may again influence the potential risk factor B. Therefore, a positive feedback loop is formed between the potential risk factors A, B, C and D. Further, due to the recurrent nature of the positive feedback loop, the potential risk factors A, B, C, and D may repetitively keep intensifying and result into an emergent risk, which may instigate the project failure. Therefore, although the potential risk factors A, B, C and D may not be individually substantial enough to instigate the project failure, but due to the formation of positive feedback loop, their combined effect may lead the project to failure. However, following the identification of the emergence pattern, the system 102 allows an organization to take risk mitigation measures to address the potential risk factors corresponding to the emergence pattern. As a result, project failure may be avoided.

In one example, “lack of coordination between onsite and offsite teams” may be referred to as the potential risk factor A. Similarly, “customer's dissatisfaction about resources”, “delay in decision-making by customer”, and “delay in complying with the schedule” may be referred to as the potential risk factors B, C, and D, respectively. Therefore, with reference to the FIG. 3(a), “lack of coordination between onsite and offsite teams” leads to the “customer's dissatisfaction about resources”, which further leads to the “delay in decision-making by the customer”. Subsequently, the “delay in decision-making by customer” leads to the “delay in complying with the schedule”. Further, the “delay in complying with the schedule” leads back to the “lack of coordination between onsite and offsite teams”. As mentioned earlier, the “lack of coordination between onsite and offsite teams” again leads to the “customer's dissatisfaction about resources”. Therefore, a positive feedback is formed between A, B, C and D.

Further, as mentioned earlier, the FIG. 3(b) illustrates a risk pattern 320, modeled on the basis of the risk interaction mapping, for identification of a risk convergence pattern, according to one embodiment of the present subject matter. As shown in the FIG. 3(b), the potential risk factors C, F, G, H, J, L, M, N, O, P and R influence the potential risk factor D. As would be gathered from the FIG. 3(b), the abovementioned potential risk factors C, F, G, . . . , and R, in combination, influence the potential risk factor D leading to instigation of project failure. Therefore, the system 102 allows an organization to mitigate risks originating from the risk convergence pattern, subsequently ensuring a successful completion of the project.

For providing better clarity, in one example, the potential risk factors such as “unrealistic project deadlines”, “customer's dissatisfaction about resources at the site”, “change in customer's requirements”, “improper distribution of workload”, “improper understanding of existing systems”, “unavailability of dedicated onsite project manager”, “delay in decision making by customer”, “lack of coordination between onsite and offsite teams”, “delay in providing necessary test environments”, “lack of suitable skill-set of team” and “incomplete requirement” may be referred to as the potential risk factors C, F, G, . . . , and R. Further, as mentioned earlier, “delay in complying with schedule” may be referred to as the potential risk factor D. Therefore, with reference to the FIG. 3(b), the “unrealistic project deadlines”, the “customer's dissatisfaction about resources at the site”, the “change in customer's requirements”, the “improper distribution of workload”, the “improper understanding of existing systems”, the “unavailability of dedicated onsite project manager”, the “delay in decision making by customer”, the “lack of coordination between onsite and offsite teams”, the “delay in providing necessary test environments”, the “lack of suitable skill-set of team” and the “incomplete requirements” may influence the “delay in complying with schedule”. Therefore, the “delay in complying with schedule” may lead to instigation of the project failure.

Similarly, the FIG. 3(c) illustrates a risk pattern 330, modeled on the basis of the risk interaction mapping, for identification of risk divergence pattern, according to one embodiment of the present subject matter. As shown in the FIG. 3(c), the potential risk factor H influences the potential risk factors A, D, G and O. As would be gathered, the potential risk factor H leads to the potential risk factors A, D, G and O. Therefore, the potential risk factor H acts as a single root cause leading to instigation of project failure. Therefore, the system 102 allows an organization to mitigate risks by identifying root cause of the project failure from the risk divergence patterns, and subsequently, ensuring a successful completion of the project.

For providing better understanding, in one example, “change in customer requirements” may be referred to as the potential risk factor H. Similarly, “lack of proper coordination between onsite and offsite teams”, “delay in complying with the schedule”, “unrealistic project deadlines”, and “improper distribution of workload” may be referred to as the potential risk factors A, D, G, and O, respectively. With reference to the FIG. 3(c), the “change in customer requirements” alone influences the “lack of proper coordination between onsite and offsite teams”, the “delay in complying with the schedule”, the “unrealistic project deadlines”, and the “improper distribution of workload”. Therefore, the “change in customer requirements” may act a single root cause for the project failure.

Although, only one type of a risk emergence pattern, a risk convergence pattern and a risk divergence pattern is illustrated in each of FIGS. 3(a), 3(b), and 3(c) respectively, the modeling module 124 may generate and identify more than one risk pattern of each type based on the risk interaction mapping.

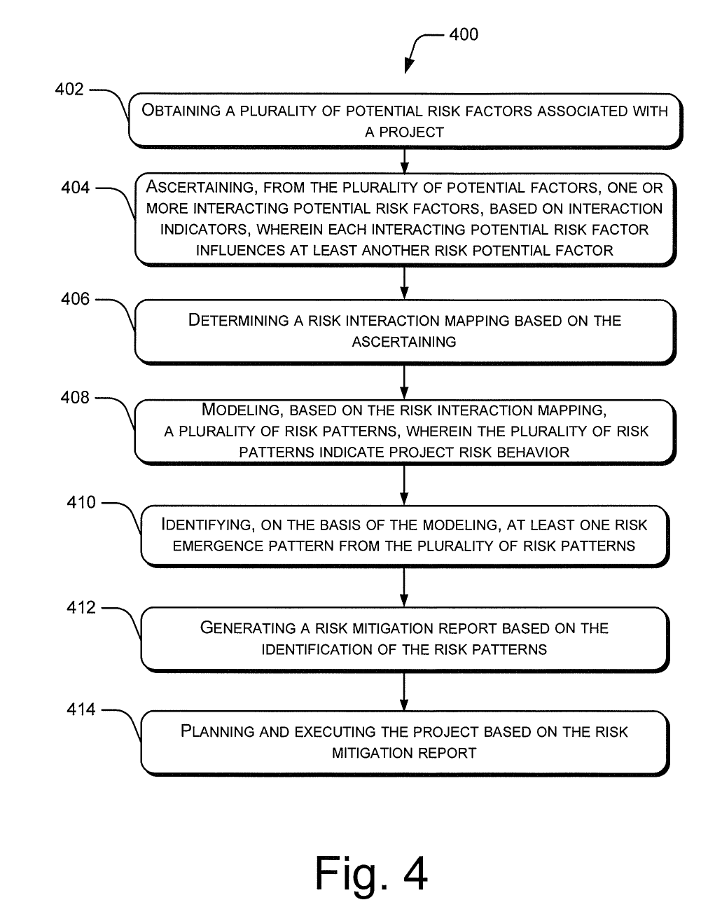

FIG. 4 illustrates a method 400 for project risk patterns modeling and risk mitigation associated with a project, according to one embodiment of the present subject matter. The method 400 may be implemented in a variety of computing systems in several different ways. For example, the method 400, described herein, may be implemented using the system 102, as described above.

The method 400, completely or partially, may be described in the general context of computer executable instructions. Generally, computer executable instructions can include routines, programs, objects, components, data structures, procedures, modules, functions, etc., that perform particular functions or implement particular abstract data types. A person skilled in the art will readily recognize that steps of the method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of the described method 400.

The order in which the method 400 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof. It will be understood that even though the method 400 is described with reference to the system 102, the description may be extended to other systems as well.

As may be understood, successful execution of various projects running in an organization ensures a prominent stature of the organization in an industry. However, there may be a plurality of risk factors associated with a project which may influence the progress of the project. Improper regulation of the risk factors may result into the project failure. Therefore, it is important to have an effective assessment and management of the risk factors associated with the project. The system 102 for risk patterns modeling and mitigation of risks associated with a project ensures an effective and productive risk management.

At block 402, a plurality of potential risk factors associated with a project may be obtained. The plurality of potential risk factors may be obtained over a network. In an example, the plurality of potential risk factors may include, but are not limited to “delay in complying with the schedule”, “unrealistic project deadlines”, “incomplete requirements”, “change in customer's requirements”, and “improper distribution of workload”. Further, an interaction indicator may be allocated with each of the plurality of potential risk factors. In one implementation, an interaction indicator may include, but are not limited to an influencing parameter and dependency parameter. The influence parameter corresponding to a potential risk factor may indicate the other potential risk factors which may be influenced by the potential risk factor. On the other hand, dependency parameter may indicate nature of dependency between two potential risk parameters. For example, a potential risk factor A may interact with a potential risk factor B, a potential risk factor C, and a potential risk factor D. Therefore, an influence parameter of an interaction indicator of the potential risk factor A may relate to the potential risk factors B, C, and D.

Continuing with the present example, the potential risk factor A may influence the potential risk factor B, whereas may get influenced by the potential risk factor C and D. Therefore, a dependency parameter of the interaction indicator of the potential risk factor A may define the dependencies of the potential risk factor A with the potential risk factor B, C, and D.

In one implementation, the interaction indicators may define dynamic attributes of the potential risk factors by considering the behavior of the potential risk factor at different stages of previous projects of similar nature. Consequently, the interaction indicator is assigned to the potential risk factor based on the behavior of potential risk factor in the current context. Therefore, interaction indicators corresponding to each of a plurality of potential risk factors may be assigned before the initiation of execution of a project. In another implementation, interaction indicators corresponding to each of the potential risk factors may be assigned or updated in each stage of the project. As would be gathered, updating of interaction indicators facilitates risk analysis at different stages of the project. In yet another implementation, interaction indicators corresponding to each of the plurality of potential risk factors may be assigned and updated based on a user preference considering the current context. In an example, a risk factor determining module 120 of the system 102 may obtain a plurality of potential risk factors associated with a project.

At block 404, from the plurality of potential risk factors, one or more potential risk factors interacting with at least another potential risk factor may be determined. In one implementation, the one or more potential risk factors may be referred to as interacting potential risk factors. The determination of the interaction potential risk factors may be determined based on the interaction indicators associated with each of the plurality of potential risk factors. In an example, a risk factor determining module 120 of the system 102 may determine a plurality of interacting potential risk factors associated with a project.

At block 406, a risk interaction mapping may be generated on the basis of ascertaining of the plurality of interacting potential risk factors. The risk interaction mapping depicts various interactions among the plurality of interacting potential risk factors. In an example, a mapping module 122 of the system 102 may generate a risk interaction mapping.

At block 408, a plurality of risk patterns may be modeled based on the risk interaction mapping. The plurality of risk patterns is indicative of behavior of the plurality of risk factors during project execution. Further, the plurality of risk patterns may include but are not limited to risk emergence patterns, risk convergence patterns and risk divergence patterns. In an example, a modeling module 124 of the system 102 may generate the plurality of risk patterns.

At block 410, a risk emergence pattern may be identified from the plurality of risk patterns on the basis of the modeling. A risk emergence pattern may be understood as a recurrent interaction between multiple potential risk factors forming a positive feedback loop. For example, a potential risk factor X influences a potential risk factor Y. Further, the potential risk factor Y influences a potential risk factor Z, wherein the potential risk factor Z influences X. Therefore, a recurrent loop is formed between the potential risk factors X, Y, and Z. If not mitigated, the potential risk factors X, Y, and Z may intensify over time and subsequently, lead to project failure.

Similarly, the risk convergence patterns may also be identified. As mentioned previously, a risk convergence pattern may determine at least one interacting potential risk factor getting influenced by two or more potential risk factors. For example, rainy day, wet road, a bump on the road, a kid crossing the road, a vehicle running at 80 miles per hour may lead to an accident. Therefore, multiple potential risk factors converge for the accident to happen.

Further, the risk divergence patterns may also be identified based on the risk interaction mapping. In one implementation, the failure of the project may be instigated by a single event. For example, heavy rainfall leads to excessive amount of water in a river. The excessive amount of water may lead to overflow of the water in the river. The overflowing river may further lead to pressure on a dam. Subsequently, the excessive pressure damages the dam leading to flood. The flood may further result into many casualties. As would be gathered, the root cause of the disaster was heavy rainfall. Therefore, the identification of the risk divergence patterns allows an organization to address a root cause of the project failure.

In one implementation, a risk modeling menu enlisting a plurality of risk patterns may be displayed on a user device 108. The user may select at least one of the plurality of risk patterns listed in the risk modeling menu. Based on the user selection, a risk pattern may be identified and displayed to a user. In an example, a modeling module 124 of the system 102 may identify a plurality of risk patterns on the basis of risk interaction mapping.

At block 412, a risk mitigation report may be generated based on the plurality of risk patterns including the risk emergence pattern. In one implementation, the risk mitigation report may provide the plurality of potential risk factors with their corresponding criticalities. In another implementation, the risk mitigation report may include mitigation measures corresponding to the identified plurality of risk patterns. Therefore, the risk mitigation report allows the organization to carry out an effective and comprehensive risk management for the project. In an example, a modeling module 124 of the system 102 may generate the risk mitigation report.

At block 414, the organization may plan the project based on the risk mitigation report. Subsequently, the organization may initiate the execution of the project based on the risk mitigation report. Therefore, the organization may adopt appropriate mitigation measures to ensure a successful execution of the project.

Although implementations of project risk patterns modeling and risk mitigation have been described in language specific to structural features and/or methods, it is to be understood that the present subject matter is not necessarily limited to the specific features or methods described. Rather, the specific features and methods are disclosed as implementations for the project risk patterns modeling and risk mitigation.

I/We claim:

1. A project risk patterns modeling and risk mitigation system for mitigating risks associated with a project, the system comprising:
a processor;
a risk factor determining module coupled to the processor, the risk factor determining module to:
obtain a plurality of potential risk factors associated with a project, wherein the plurality of potential risk factors influence progress of the project; and
ascertain, from the plurality of potential risk factors, at least one interacting potential risk factor influencing at least another potential risk factor, the ascertaining being based on interaction indicators, wherein the interaction indicators are indicative of an interaction between the at least one interacting potential risk factor and the at least other potential risk factor; and
a modeling module to identify a risk emergence pattern based on the interaction between the at least one interacting potential risk factor and the at least other potential risk factor, the risk emergence pattern being indicative of a recurrent interaction between the at least one interacting potential risk factor and the at least other potential risk factor, wherein the project is executed based on the identifying.

2. The project risk patterns modeling and risk mitigation system as claimed in claim 1 further comprising a mapping module for determining, based on the ascertaining, a risk interaction mapping, wherein the risk interaction mapping depicts an interaction among the plurality of potential risk factors.

3. The project risk patterns modeling and risk mitigation system as claimed in claim 2, wherein the modeling module generates, based on the risk interaction mapping, a plurality of risk patterns, wherein the plurality of risk patterns are indicative of behavior of the plurality of potential risk factors during project execution.

4. The project risk patterns modeling and risk mitigation system as claimed in claim 1, wherein the modeling module identifies a risk convergence pattern corresponding to the plurality of potential risk factors, wherein the risk convergence pattern is indicative of a project failure due to one potential risk factor influenced by a plurality of potential risk factors.

5. The project risk patterns modeling and risk mitigation system as claimed in claim 1, wherein the modeling module identifies a risk divergence pattern corresponding to the plurality of potential risk factors, wherein the risk divergence pattern is indicative of a project failure due to a plurality of risk factors influenced by one potential risk factor.

6. The project risk patterns modeling and risk mitigation system as claimed in claim 1, wherein the modeling module generates a risk mitigation report based on identification of a plurality of risk patterns, wherein the plurality of risk patterns include at least one of the risk emergence pattern, a risk convergence pattern and a risk divergence pattern.

7. The project risk patterns modeling and risk mitigation system as claimed in claim 1, wherein an interaction indicator comprises at least one of an influencing parameter and a dependency parameter.

8. The project risk patterns modeling and risk mitigation system as claimed in claim 1, wherein the interaction indicators corresponding to each of the plurality of potential risk factors are updated in each stage of the project based on dynamic attributes of the potential risk factors.

9. A computer implemented method for project risk patterns modeling and risk mitigation, the method comprising:
obtaining a plurality of potential risk factors associated with a project, the plurality of potential risk factors being obtained over a network, wherein the plurality of potential risk factors influence progress of the project;
ascertaining, from the plurality of potential risk factors, at least one interacting potential risk factor influencing at least another potential risk factor, the ascertaining being based on one or more interaction indicators, wherein the interaction indicators are indicative of an interaction between the at least one interacting potential risk factor and the at least other potential risk factor;
determining, based on the ascertaining, a risk interaction mapping, wherein the risk interaction mapping depicts an interaction among the plurality of potential risk factors;
modeling, automatically, a plurality of risk patterns based on the risk interaction mapping; and
identifying at least one risk emergence pattern from the plurality of risk patterns, the risk emergence pattern being indicative of a recurrent interaction between the at least one interacting potential risk factor and the at least other potential risk factor, wherein the project is executed based on the identifying.

10. The method as claimed in claim 9, wherein the method further comprises identifying a risk convergence pattern corresponding to the plurality of potential risk factors, wherein the risk convergence pattern is indicative of a project failure due to one potential risk factor influenced by each of a plurality of potential risk factors.

11. The method as claimed in claim 9, wherein the method further comprises identifying a risk divergence pattern corresponding to the plurality of potential risk factors, wherein the risk divergence pattern is indicative of a project failure due to a plurality of potential risk factors influenced by one potential risk factor.

12. The method as claimed in claim 9, wherein the method further comprises generating a risk mitigation report based on identification of a plurality of risk patterns, wherein the plurality of risk patterns include at least one of the risk emergence pattern, a risk convergence pattern and a risk divergence pattern.

13. The method as claimed in claim 9, wherein an interaction indicator is assigned to each of the plurality of the potential risk factors.

14. The method as claimed in claim 9, wherein the interaction indicators corresponding to each of the plurality of potential risk factors are updated in each stage of the project based on dynamic attributes of the potential risk factors.

15. A non-transitory computer-readable medium having embodied thereon a computer program for executing a method comprising
obtaining a plurality of potential risk factors associated with a project, the plurality of potential risk factors being obtained over a network, wherein the plurality of potential risk factors influence progress of the project;
ascertaining, from the plurality of potential risk factors, at least one interacting potential risk factor influencing at least another potential risk factor, the ascertaining being based on one or more interaction indicators, wherein the interaction indicators are indicative of an interaction between the at least one interacting potential risk factor and the at least other potential risk factor;
determining, based on the ascertaining, a risk interaction mapping, wherein the risk interaction mapping depicts an interaction among the plurality of potential risk factors;
modeling, automatically, a plurality of risk patterns based on the risk interaction mapping; and
identifying at least one risk emergence pattern from the plurality of risk patterns, the risk emergence pattern being indicative of a recurrent interaction between the at least one interacting potential risk factor and the at least other potential risk factor, wherein the project is executed based on the identifying.

16. The non-transitory computer-readable medium as claimed in claim 15, wherein the method further comprises identifying a risk convergence pattern corresponding to the plurality of potential risk factors, wherein the risk convergence pattern is indicative of a project failure due to one potential risk factor influenced by each of a plurality of potential risk factors.

17. The non-transitory computer-readable medium as claimed in claim 15, wherein the method further comprises identifying a risk divergence pattern corresponding to the plurality of potential risk factors, wherein the risk divergence pattern is indicative of a project failure due to a plurality of potential risk factors influenced by one potential risk factor.

18. The non-transitory computer-readable medium as claimed in claim 15, wherein an interaction indicator is assigned to each of the plurality of the potential risk factors.

19. The non-transitory computer-readable medium as claimed in claim 15, wherein the interaction indicators comprises an influence parameter and a dependency parameter.

20. The non-transitory computer-readable medium as claimed in claim 15, wherein the interaction indicators corresponding to each of the plurality of potential risk factors are updated in each stage of the project based on dynamic attributes of the potential risk factors.
